(19) United States
(12) Patent Application Publication
(10) Pub. No.: US 2016/0062714 A1
(43) Pub. Date: Mar. 3, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Yuji YONEDA, Kanagawa (JP)

(21) Appl. No.: 14/667,017

(22) Filed: Mar. 24, 2015

(30) Foreign Application Priority Data
Aug. 26, 2014 (JP) 2014-171325

(51) Int. Cl. G06F 3/12

(52) U.S. Cl. CPC G06F 3/1243; G06F 3/1208; G06F 3/125

(57) ABSTRACT

An information processing apparatus includes a type generating unit and a to-be-distributed material generating unit. The type generating unit generates a type of material to be distributed, according to a rule predetermined for each of forms of the to-be-distributed material. The type is a type in which a position at which content is described in the to-be-distributed material is determined. The to-be-distributed material generating unit generates the to-be-distributed material by applying priority to the generated type of the to-be-distributed material and by disposing the content in the to-be-distributed material. The priority is obtained in accordance with the distance between a first location and a second location. The first location is related to the content described in the to-be-distributed material. The second location is a distribution location for the to-be-distributed material.

### CROSS-REFERENCE TO RELATED APPLICATIONS

This application is based on and claims priority under 35 USC 119 from Japanese Patent Application No. 2014-171325 filed Aug. 26, 2014.

### BACKGROUND

### Technical Field

The present invention relates to an information processing apparatus, an information processing method, and a non-transitory computer readable medium.

### SUMMARY

According to an aspect of the invention, there is provided an information processing apparatus including a type generating unit and a to-be-distributed material generating unit. The type generating unit generates a type of to-be-distributed material which is to be distributed, according to a rule predetermined for each of forms of the to-be-distributed material. The type is a type in which a position at which content is described in the to-be-distributed material is determined. The to-be-distributed material generating unit generates the to-be-distributed material by applying priority to the type of the to-be-distributed material and by disposing the content in the to-be-distributed material. The type is generated by the type generating unit. The priority is obtained in accordance with a distance between a first location and a second location. The first location is related to the content described in the to-be-distributed material. The second location is a distribution location for the to-be-distributed material.

### BRIEF DESCRIPTION OF THE DRAWINGS

Exemplary embodiment of the present invention will be described in detail based on the following figures, wherein:

FIG. 1 is a schematic diagram illustrating an exemplary module configuration according to an exemplary embodiment;

FIG. 2 is a diagram for describing an exemplary system configuration used when the exemplary embodiment is achieved;

FIGS. 3A to 3C are diagrams for describing exemplary forms of a sheet to be distributed;

FIG. 4 is a diagram for describing an exemplary template;

FIG. 5 is a diagram for describing an exemplary data structure of a content information table;

FIGS. 6A and 6B are diagrams for describing exemplary processing according to the exemplary embodiment;

FIGS. 7A to 7C are diagrams for describing exemplary processing according to the exemplary embodiment;

FIGS. 8A and 8B are diagrams for describing exemplary processing according to the exemplary embodiment;

FIG. 9 is a diagram for describing exemplary processing according to the exemplary embodiment;

FIG. 10 is a diagram for describing an exemplary data structure of a content information (with distance order) table;

FIG. 11 is a diagram for describing exemplary processing according to the exemplary embodiment;

FIG. 12 is a flowchart of an exemplary process according to the exemplary embodiment; and

FIG. 13 is a block diagram illustrating an exemplary hardware configuration of a computer achieving the exemplary embodiment.

### DETAILED DESCRIPTION

An exemplary embodiment suitable to embody the present invention will be described below on the basis of the drawings.

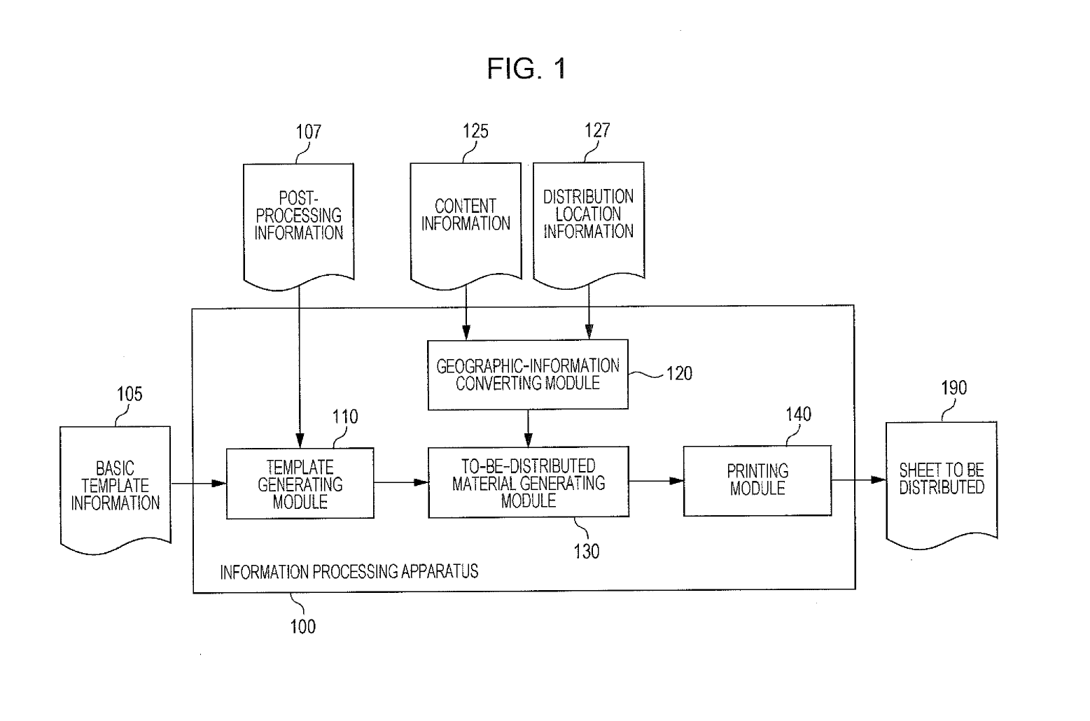

FIG. 1 is a schematic diagram illustrating an exemplary module configuration according to the present exemplary embodiment.

In general, a module refers to a component, such as software (a computer program) that is logically separable or hardware. Thus, a module in the exemplary embodiment refers to not only a module in terms of a computer program but also a module in terms of a hardware configuration. Consequently, the description of the exemplary embodiment also serves as a description of a system, a method, and a computer program which cause the hardware configuration to function as a module (a program that causes a computer to execute procedures, a program that causes a computer to function as units, or a program that causes a computer to implement functions). For convenience of explanation, the terms “to store something” and “to cause something to store something”, and equivalent terms are used. These terms mean that a storage apparatus stores something or that a storage apparatus is controlled so as to store something, when computer programs are used in the exemplary embodiment. One module may correspond to one function. However, in the implementation, one program may constitute one module, or one program may constitute multiple modules. Alternatively, multiple programs may constitute one module. Additionally, multiple modules may be executed by one computer, or one module may be executed by multiple computers in a distributed or parallel processing environment. One module may include another module. Hereinafter, the term “connect” refers to logical connection, such as transmission/reception of data, an instruction, or reference relationship between pieces of data, as well as physical connection. The term “predetermined” refers to a state in which determination has been made before a target process. This term also includes a meaning in which determination has been made in accordance with the situation or the state at that time or the situation or the state before that time, not only before processes according to the exemplary embodiment start, but also before the target process starts even after the processes according to the exemplary embodiment have started. When multiple “predetermined values” are present, these may be different from each other, or two or more of the values (including all values, of course) may be the same. A description having a meaning of “when A is satisfied, B is performed” is used as having a meaning of “whether or not A is satisfied is determined and, when it is determined that A is satisfied, B is performed”. However, this term does not include a case where the determination of whether or not A is satisfied is unnecessary.

A system or an apparatus refers to one in which multiple computers, pieces of hardware, devices, and the like are connected to each other by using a communication unit such as a network which includes one-to-one communication connection, and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (social system) operating on man-made agreements.

In each of the processes performed by modules, or in each of the processes performed in a module, target information is read out from a storage apparatus. After the process is performed, the processing result is written in a storage apparatus. Accordingly, no description about the reading of data from the storage apparatus before the process and the writing into the storage apparatus after the process may be made. Examples of the storage apparatus may include a hard disk, a random access memory (RAM), an external storage medium, a storage apparatus via a communication line, and a register in a central processing unit (CPU).

An information processing apparatus 100 according to the present exemplary embodiment produces sheets to be distributed. As illustrated in FIG. 1, the information processing apparatus 100 includes a template generating module 110, a geographic-information converting module 120, a to-be-distributed material generating module 130 (hereinafter referred to as a distribution-material generating module 130), and a printing module 140.

For example, in order to display data (specifically, for example, data about a shop located at a position close to a person receiving a distributed sheet such as a handout) related to the person, at a conspicuous position in the sheet with high priority, when the information processing apparatus 100 is to produce sheets to be distributed, the information processing apparatus 100 receives geographic information of a distribution location where the sheets are to be distributed, and compares, with each other, pieces of geographic information in pieces of data (hereinafter also referred to as content) to be inserted into a type (hereinafter also referred to as a template) of the sheets to be distributed. Then, the information processing apparatus 100 rearranges the pieces of data in ascending order of the distance from the distribution location, and prints the pieces of data.

A sheet to be distributed is a sheet on which single-sided or double-sided printing has been performed, and is printed matter having content including multiple pieces of geographic information such as information about multiple shops. The sheet to be distributed has one or more pages. It is assumed that the sheet is distributed without being folded, or is folded and distributed. An example of distribution is a case in which the sheets are distributed to an indefinite number of people, for example, in front of a station, on a street, or in front of a shop.

The template generating module 110 connected to the distribution-material generating module 130 receives basic template information 105 and post-processing information 107. The template generating module 110 generates a type which is set for the sheet to be distributed and in which positions at which pieces of content are described on the sheet are determined according to a rule predetermined for each of the forms of the sheet. An example of the “predetermined rule” may be a rule that higher priority is given to areas located on the front surface of a sheet to be distributed, in accordance with the form of the sheet. The form of a sheet to be distributed is set by using the post-processing information 107. The post-processing information 107 is information indicating what kind of post-processing is to be performed on a sheet 190 to be distributed.

FIGS. 3A to 3C illustrate examples of the post-processing information 107. FIGS. 3A to 3C are diagrams for describing the forms of a sheet to be distributed. A sheet 190a to be distributed, which is illustrated in the example in FIG. 3A, is a “half-fold” sheet 190, and has four pages in total. A sheet 190b to be distributed, which is illustrated in the example in FIG. 3B, is a “tri-fold (three panel roll fold)” sheet 190, and has six pages in total. A sheet 190c to be distributed, which is illustrated in the example in FIG. 3C, is a “tri-fold (Z-fold)” sheet 190, and has six pages in total.

When these forms of a sheet 190 are employed, the front surface (pages viewable after the post-processing is performed) of the sheet corresponds to the pages on one side (outer side) in the case of the sheet 190a illustrated in the example in FIG. 3A, two pages on one side (outer side) in the case of the sheet 190b illustrated in the example in FIG. 3B, and one page on a first outer side and one page on a second outer side in the case of the sheet 190c illustrated in the example in FIG. 3C. That is, conspicuous areas on a sheet 190 depend on the post-processing information 107.

In addition to the kind of folding as described above (the number of folding operations, how to fold the sheet), examples of “the forms of a sheet to be distributed” include whether or not a sheet 190 is to be inserted into an envelope. When the sheet 190 is to be inserted into an envelope, the examples also include whether or not the entire area of the envelope is transparent, whether or not one side of the envelope is transparent, where a transparent portion (window) in the envelope is, and whether or not the sheet 190 is to be pressed. When the sheet 190 has multiple pages, the examples also include a page sequence.

The post-processing information 107 may be predetermined, or may be selected in response to an instruction supplied from a user.

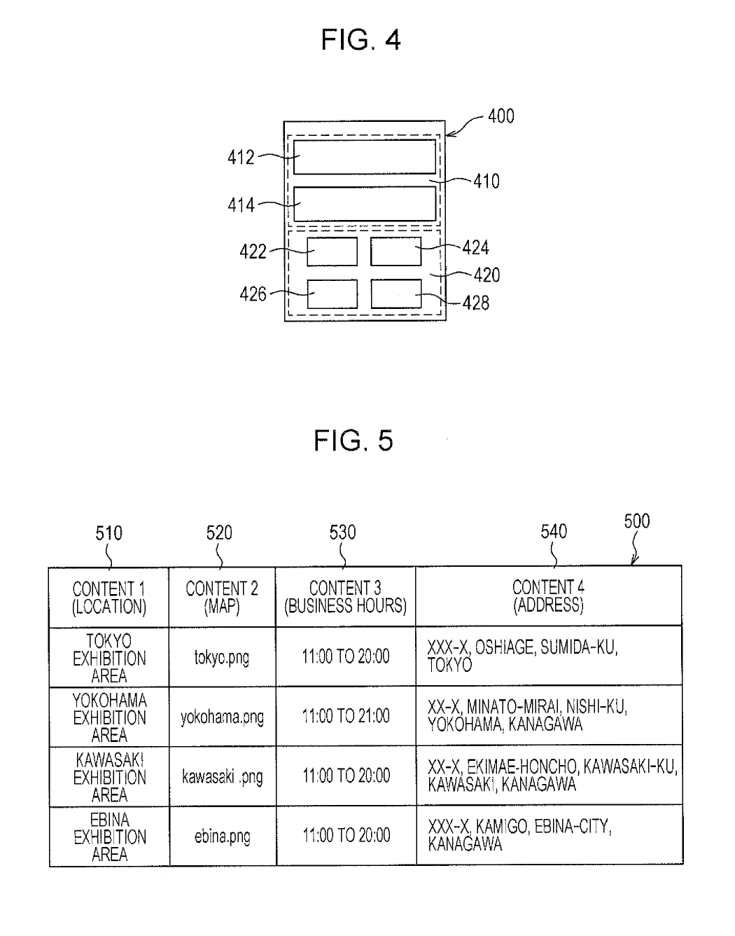

The basic template information 105 is object frame information of a predetermined template. A user selects a template suitable for a sheet to be distributed this time, from multiple templates. FIG. 4 is a diagram for describing exemplary basic template information 105. For example, a basic template 400 is constituted by two segments, a variable segment (normal) 410 and a variable segment (sortable according to geographic information) 420 which is hereinafter referred to as a variable segment (sortable) 420. The variable segment (normal) 410 includes, for example, two areas, object frames 412 and 414. The variable segment (sortable) 420 includes, for example, four areas, object frames 422, 424, 426, and 428. Content such as advertisement information of a shop is inserted into the object frame 412 and the like, whereby the sheet 190 is finished. The content in an object frame in the variable segment (normal) 410 is predetermined, whereas the content in an object frame in the variable segment (sortable) 420 is determined in accordance with the distribution location where the sheet 190 is to be distributed.

The geographic-information converting module 120 connected to the distribution-material generating module 130 receives content information 125 and distribution location information 127. From the geographic information in the content information representing a first location and the distribution location information representing a second location, the geographic-information converting module 120 calculates the distance between the first location and the second location.

When the geographic information or the distribution location information is information other than coordinates information, the geographic-information converting module 120 may convert the information, which is other than coordinates information, into coordinates information so as to calculate the distance between the first location and the second location by using the coordinates information.

The content information 125 represents content described on the sheet 190. As illustrated in the example in FIG. 4, there are content information disposed in the variable segment (normal) 410 and content information disposed in the variable segment (sortable) 420.

Similarly to an existing template publishing technique, examples of the content information disposed in the variable segment (normal) 410 include text and images which are to be printed.

Similarly to the content information disposed in the variable segment (normal) 410, examples of the content information disposed in the variable segment (sortable) 420 include text and images. In addition, the examples also include geographic information (such as an address). However, the geographic information is not necessarily printed directly on the sheet 190, and it is sufficient that the geographic information be associated with data (content) to be printed. An example of the content information is a content information table 500. FIG. 5 is a diagram for describing an exemplary data structure of the content information table 500. The content information table 500 includes a content 1 (location) column 510, a content 2 (map) column 520, a content 3 (business hours) column 530, and a content 4 (address) column 540. Content 1 (location) of a shop or the like is stored in the content 1 (location) column 510. Content 2 (map) of the shop of the like is stored in the content 2 (map) column 520. Content 3 (business hours) of the shop or the like is stored in the content 3 (business hours) column 530. Content 4 (geographic information) of the shop or the like is stored in the content 4 (address) column 540. The content 1 (location) column 510, the content 2 (map) column 520, and the content 3 (business hours) column 530 correspond to data to be printed. The content 4 (address) column 540 corresponds to geographic information. Information in the content 4 (address) column 540 is not necessarily printed on the sheet 190.

The distribution location information 127 which is information about a distribution location is received in response to a user operation through a keyboard, a mouse, a touch panel, and the like. The distribution location information 127 represents an address, landmark information, or the like. The landmark information represents a facility name or the like, such as Tokyo Sky Tree, Landmark Tower, Kanagawa Prefectural Government Building, or Yokohama Station. A user may indicate a position in a map, whereby coordinates information (latitude-longitude information) is received.

The distribution-material generating module 130 is connected to the template generating module 110, the geographic-information converting module 120, and the printing module 140. The distribution-material generating module 130 generates material to be distributed (hereinafter referred to as to-be-distributed material), by applying priority obtained by using the distance between the first location for the content described on the sheet to be distributed and the second location where the sheet is to be distributed, to the type for the sheet which is generated by the template generating module 110, and by arranging the content on the sheet.

The distribution-material generating module 130 may generate to-be-distributed material by applying priority in ascending order of the distance calculated by the geographic-information converting module 120.

The printing module 140 connected to the distribution-material generating module 130 outputs the sheet 190. The printing module 140 receives the to-be-distributed material information generated by the distribution-material generating module 130, generates images from the to-be-distributed material information, and prints the images. For example, the images are printed by, for example, a printer, and/or are transmitted by using an image transmitting apparatus such as a facsimile. In addition, for example, the images may be displayed on a display apparatus such as a display, may be written into an image storage apparatus such as an image database, may be stored in a storage medium such as a memory card, and/or may be transmitted to another information processing apparatus.

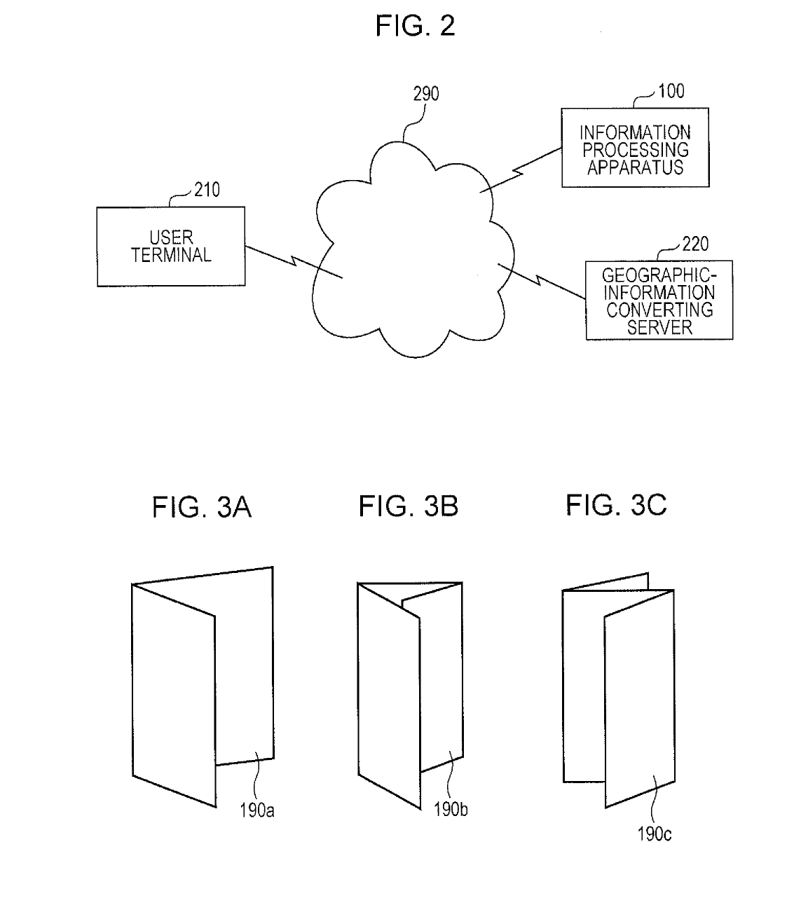

FIG. 2 is a diagram for describing an exemplary system configuration used when the present exemplary embodiment is achieved.

The information processing apparatus 100, a user terminal 210, and a geographic-information converting server 220 are connected to each other via a communication line 290. The communication line 290 may be a wireless line, a wired line, or a combination of these. For example, the communication line 290 may be the Internet or the like serving as a communication infrastructure. The user terminal 210 receives the post-processing information 107, the content information 125, and the distribution location information 127 on the basis of a user instruction, and transmits the received information to the information processing apparatus 100. The geographic-information converting server 220 receives the geographic information or the distribution location information which is information other than coordinates information, from the geographic-information converting module 120 of the information processing apparatus 100, converts the geographic information or the distribution location information into coordinates information, and returns the resulting coordinates information back to the geographic-information converting module 120 of the information processing apparatus 100. The communication line 290 is connected to printers. The information processing apparatus 100 may transmit the to-be-distributed material generated by the distribution-material generating module 130 to a printer located close to the distribution location so as to cause the printer to print the sheet 190.

The template generating module 110 determines priority for object frames in a template, from the post-processing information 107 and the template information. The priority is determined depending on how conspicuous an object frame is, and depends on the post-processing. Specifically, the priority is given in the following manner. An upper-left object frame (upper-right object frame in the case of vertical writing) on the front surface (surface coming into sight at first) is given the highest priority. The priority gets lower in the right direction (downward in the case of vertical writing). When an object frame located on the right end (lower end in the case of vertical writing) is given the priority, the priority is given to the object frames located in the next downward line (line adjacent on the left side in the case of vertical writing). When giving the priority to the object frames on the front surface is completed, the object frames on a surface which comes into sight next are given the priority.

The method of determining the priority may be determined in accordance with another rule. For example, when the size of an object frame is different from that of another, the priority may be determined in order of the size. Multiple patterns of rules may be prepared, or a user may select a rule when the basic template information 105 is to be selected.

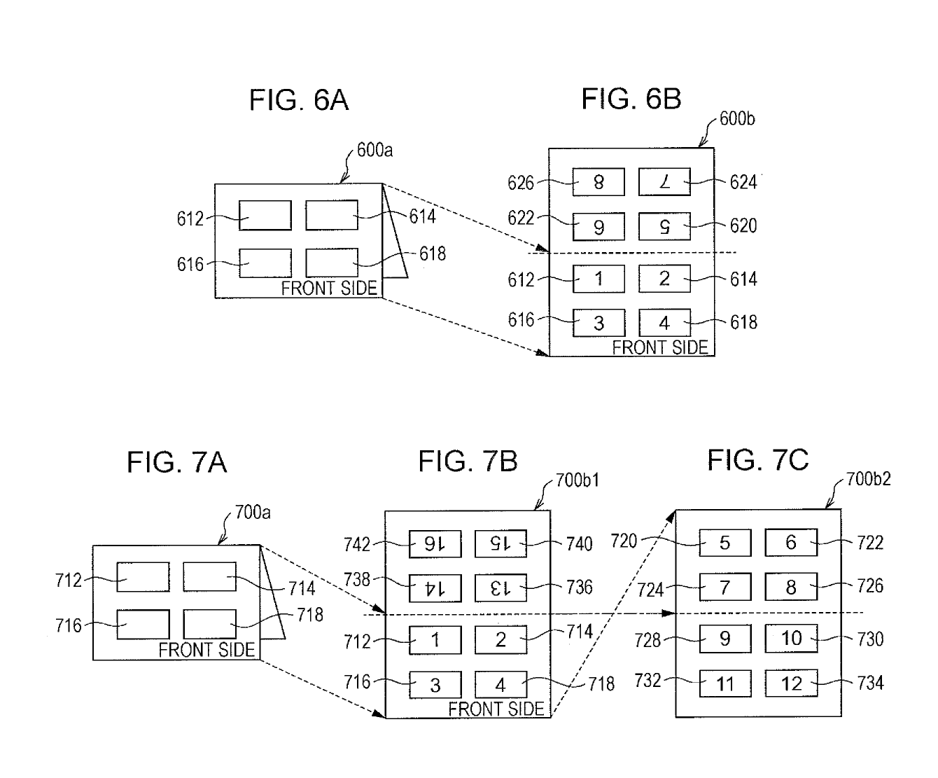

FIGS. 6A and 6B are diagrams for describing exemplary processing (performed by the template generating module 110) according to the present exemplary embodiment. This example describes a rule for half fold and “high priority given to the outer surface”.

A template 600a illustrated in the example in FIG. 6A is half folded in the post-processing, and has object frames 612, 614, 616, and 618 on the front surface. The state before the template 600a is half folded is illustrated as a template 600b which is in the example in FIG. 6B and which has object frames 612, 614, 616, 618, 620, 622, 624, and 626. These object frames are included in the variable segment (sortable) 420 described in the example in FIG. 4.

The numbers illustrated in the object frames of the template 600b illustrated in the example in FIG. 6B indicate where objects are to be shown on the sheet 190, according to the rule predetermined for half fold (which is an exemplary form of a sheet to be distributed). That is, the priority is assigned from high to low to the object frames 612, 614, 616, 618, 620, 622, 624, and 626 in this sequence. The predetermined rule is such that, in the form of half fold, the priorities for the areas (object frames 612, 614, 616, and 618) on the front surface of the sheet 190 are set higher than those for the areas (object frames 620, 622, 624, and 626) on the back side.

FIGS. 7A to 7C are diagrams for describing exemplary processing (performed by the template generating module 110) according to the present exemplary embodiment. This example describes a rule for a half-folded duplex-printing template having “priority according to the order of opening a folded sheet”.

A template 700a illustrated in the example in FIG. 7A is half folded in the post-processing, and has object frames 712, 714, 716, and 718 on the front surface. The state before the template 700a is half folded is illustrated as a template (front side) 700b1 and a template (reverse side) 700b2 in the example in FIGS. 7B and 7C. The template (front side) 700b1 has object frames 712, 714, 716, 718, 736, 738, 740, and 742. The template (reverse side) 700b2 has object frames 720, 722, 724, 726, 728, 730, 732, and 734. These object frames are included in the variable segment (sortable) 420 described in the example in FIG. 4.

The numbers illustrated in the object frames of the template (front side) 700b1 and the template (reverse side) 700b2 illustrated in the examples in FIGS. 7B and 7C indicate where objects are to be shown on the sheet 190, according to the rule predetermined for duplex printing and half fold (which are an exemplary form of a sheet to be distributed). That is, the priority is assigned from high to low to the object frames 712, 714, 716, and 718 printed on the first page, the object frames 720, 722, 724, and 726 printed on the second page, the object frames 728, 730, 732, and 734 printed on the third page, and the object frames 736, 738, 740, and 742 printed on the fourth page, in this sequence. The predetermined rule is such that, in the form of duplex printing and half fold, the priorities for the areas (object frames 712, 714, 716, and 718) on the first page of the sheet 190 are set higher than those for the areas (such as the object frame 720) on the other pages.

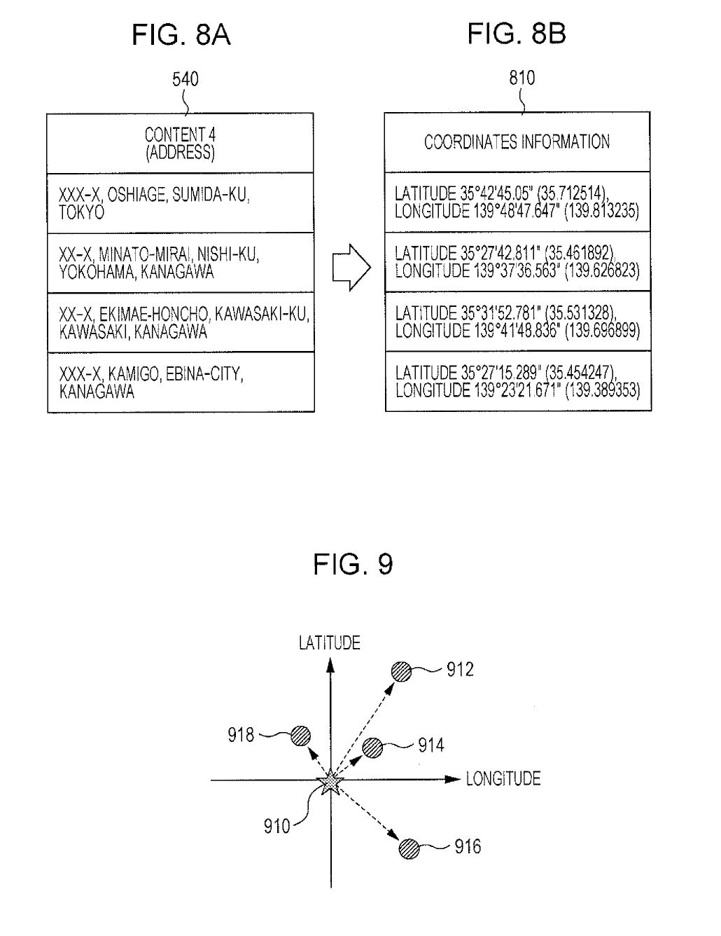

FIGS. 8A and 83 are diagrams for describing exemplary processing (performed by the geographic-information converting module 120) according to the present exemplary embodiment. The geographic-information converting module 120 calculates the distance between the distribution location and the geographic information.

The content 4 (address) column 540 illustrated in the example in FIG. 8A is obtained by extracting the content 4 (address) column 540 from the content information table 500 illustrated in the example in FIG. 5. The geographic-information converting module 120 converts the content 4 (address) column 540 into a coordinates information column 810. The distribution location information is received as landmark information, address information, or coordinates information. In the case of landmark information or address information (information other than coordinates information), coordinates information is finally obtained by performing conversion as follows.

For example, landmark information is converted into address information. The address information is converted into coordinates information. Thus, landmark information or address information is converted into coordinates information. This conversion may be performed by using an existing technique. For example, a service provided by google or the like (http://www.geocoding.jp/), an application programming interface (API) for other service having an equivalent function, and the like are used to achieve this conversion.

Landmark information “Tokyo Sky Tree” is converted into address information “1-1-2, Oshigae, Sumida-ku, Tokyo”. Then, the address information is converted into coordinates information “latitude 35° 42′36.227” (35.710063), longitude 139° 48′38.52″ (139.8107)”.

The geographic-information converting module 120 calculates the distance between two points, the distribution location and the location for a piece of the content (specifically, the address of a shop).

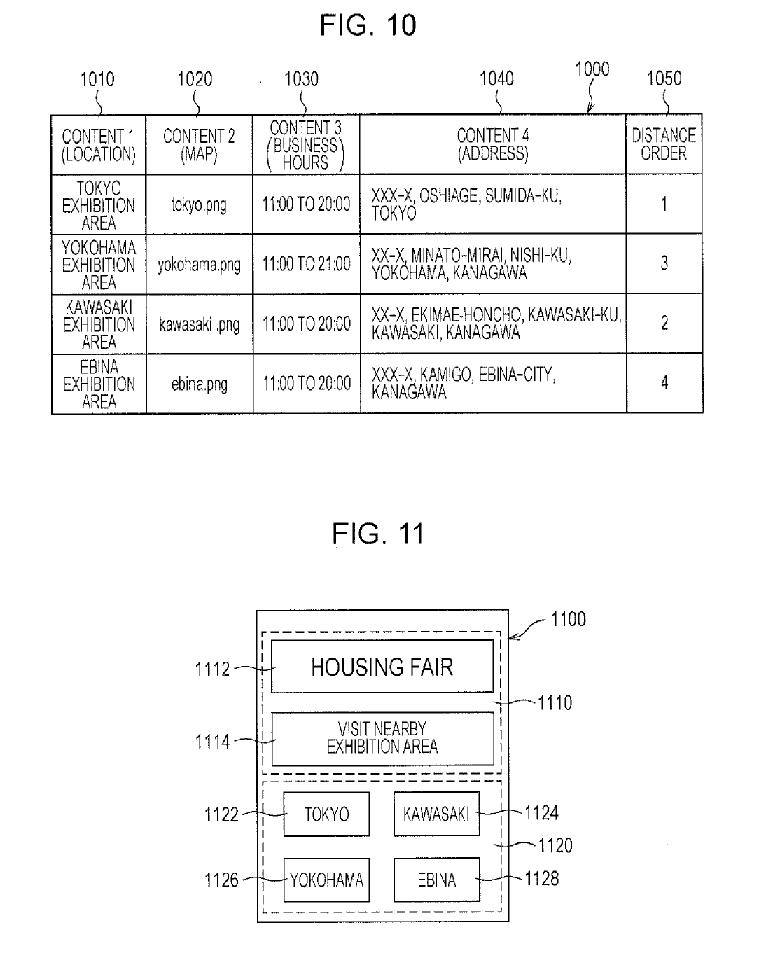

FIG. 9 is a diagram for describing exemplary processing (performed by the geographic-information converting module 120) according to the present exemplary embodiment. Distribution position coordinates 910 are used as a reference point. The difference between the reference point and the coordinates information of each piece of the content is obtained and the distance is calculated. The distances are used to sort the pieces of content in ascending order (in the order from the closest to the distribution location). In the example in FIG. 9, the order of content coordinates 914 (Tokyo Exhibition Area), content coordinates 918 (Kawasaki Exhibition Area), content coordinates 916 (Yokohama Exhibition Area), and content coordinates 912 (Ebina Exhibition Area) is obtained. FIG. 10 is a diagram for describing an exemplary data structure of a content information (with distance order) table 1000. The content information (with distance order) table 1000 includes a content 1 (location) column 1010, a content 2 (map) column 1020, a content 3 (business hours) column 1030, a content 4 (address) column 1040, and a distance order column 1050. The content information (with distance order) table 1000 is obtained by adding the distance order column 1050 to the content information table 500 illustrated in the example in FIG. 5. That is, the content 1 (location) is stored in the content 1 (location) column 1010. The content 2 (map) is stored in the content 2 (map) column 1020. The content 3 (business hours) is stored in the content 3 (business hours) column 1030. The content 4 (address) is stored in the content 4 (address) column 1040. The distance order is stored in the distance order column 1050. The distance order also serves as the priority order for the areas on the sheet 190.

The distribution-material generating module 130 inserts the content information 125 into the template generated by the template generating module 110, and generates data for printing the sheet 190. The content information 125 is inserted into the template in such a manner that a piece of content having a shorter distance is inserted into an object frame of the template which has a higher priority.

FIG. 11 is a diagram for describing exemplary processing (performed by the distribution-material generating module 130) according to the present exemplary embodiment. A sheet 1100 to be distributed has a variable area (normal) 1110 and a variable area (sortable according to geographic information) 1120 (hereinafter referred to as a variable area (sortable) 1120). The variable area (normal) 1110 has an object frame 1112 and an object frame 1114. The variable area (sortable) 1120 has an object frame 1122, an object frame 1124, an object frame 1126, and an object frame 1128. That is, FIG. 11 illustrates the sheet 1100 obtained by giving priority to the object frames in the basic template 400 illustrated in the example in FIG. 4 (the object frame 422, i.e., 1122, is given the highest priority, the object frame 424, i.e., 1124, is given the second-highest priority, the object frame 426, i.e., 1126, is given the third-highest priority, and the object frame 428, i.e., 1128, is given the fourth-highest priority), and inserting content corresponding to each line in the content information (with distance order) table 1000 illustrated in the example in FIG. 10 into the object frames. Specifically, predetermined information (such as advertisement text of “housing fair and the like”) is described in the object frames 1112 and 1114; content about “Tokyo Exhibition Area” is disposed in the object frame 1122; content about “Kawasaki Exhibition Area” is disposed in the object frame 1124; content about “Yokohama Exhibition Area” is disposed in the object frame 1126; and content about “Ebina Exhibition Area” is disposed in the object frame 1128. The order of the object frames 1122, 1124, 1126, and 1128 depends on a location where the sheet 1100 is to be distributed.

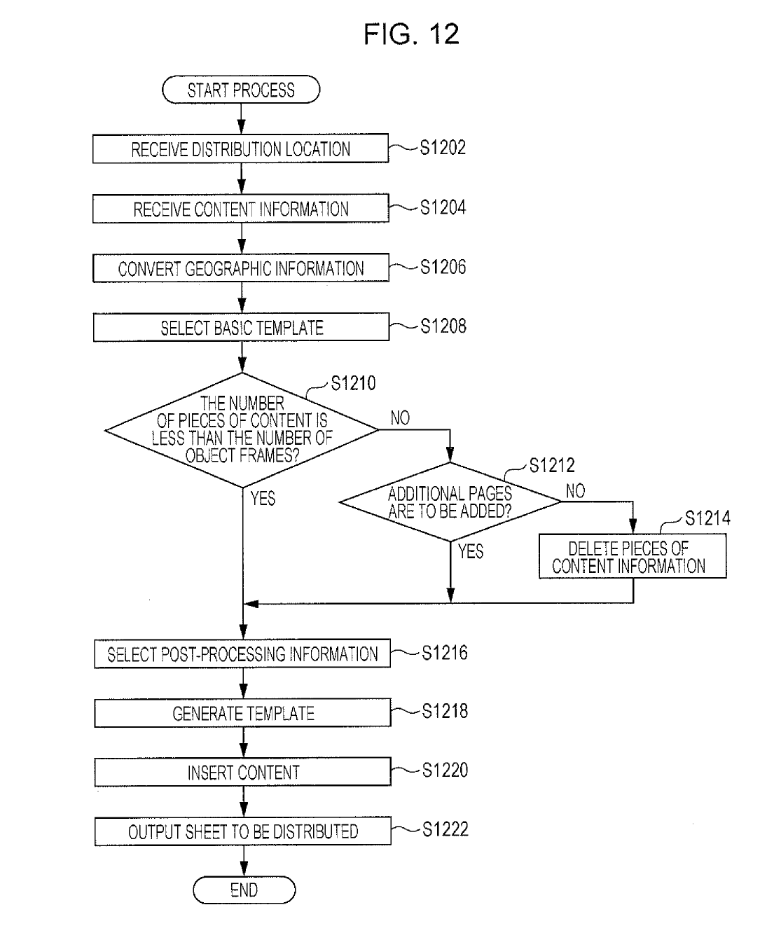

FIG. 12 is a flowchart of an exemplary process according to the present exemplary embodiment.

In step S1202, the geographic-information converting module 120 receives the distribution location information 127.

In step S1204, the geographic-information converting module 120 receives the content information 125.

In step S1206, the geographic-information converting module 120 converts geographic information into coordinates information. The geographic-information converting module 120 calculates distances from pieces of the coordinates information for the content and the distribution location coordinates information, and determines the order according the distances.

In step S1208, the template generating module 110 selects a basic template.

In step S1210, the distribution-material generating module 130 determines whether or not the number of pieces of content is equal to or less than the number of object frames in the basic template. If the number of pieces of content is equal to or less than the number of object frames in the basic template, the process proceeds to step S1216. Otherwise, the process proceeds to step S1212.

In step S1212, the distribution-material generating module 130 determines whether or not additional pages are to be added. If additional pages are to be added, the process proceeds to step S1216. Otherwise, the process proceeds to step S1214. Whether or not additional pages are to be added is determined, for example, in accordance with an instruction supplied through a selection operation performed by a user.

In step S1214, the distribution-material generating module 130 deletes pieces of the content information. The pieces to be deleted are determined, for example, by an instruction supplied through a selection operation performed by the user.

In step S1216, the template generating module 110 selects the post-processing information 107.

In step S1218, the template generating module 110 generates a template (a template in which the object frames are given priority) from the basic template in accordance with the post-processing information 107.

In step S1220, the distribution-material generating module 130 inserts the content having priorities into the template generated in step S1218.

In step S1222, the printing module 140 outputs the sheet 190.

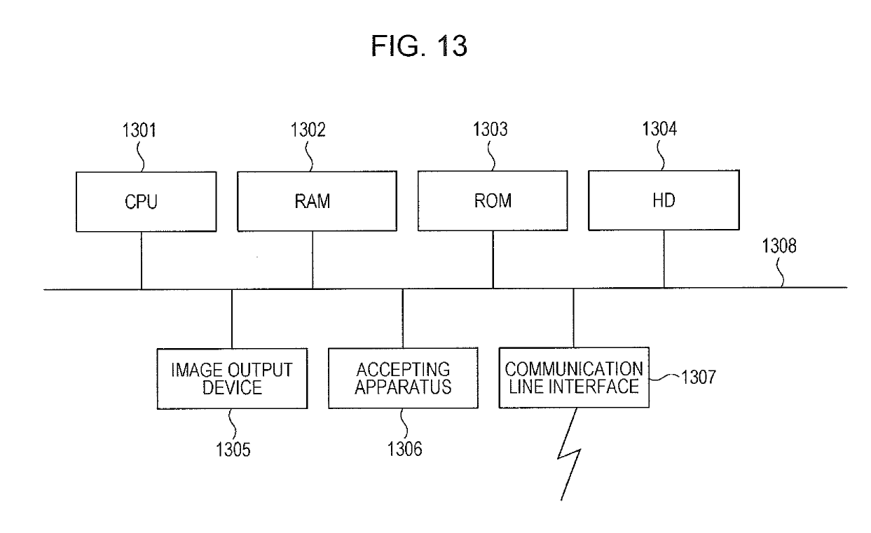

As illustrated in FIG. 13, the hardware configuration of a computer in which programs achieving the exemplary embodiment are executed constitutes a typical computer, and specifically, constitutes a computer or the like which may serve as a personal computer or a server. That is, for example, the configuration employs a CPU 1301 as a processor (arithmetic logical unit), and employs a RAM 1302, a read-only memory (ROM) 1303, and an HD 1304 as storage devices. For example, a hard disk or a solid state drive (SSD) may be used as the HD 1304. The computer includes the following components: the CPU 1301 which executes programs, such as the template generating module 110, the geographic-information converting module 120, the distribution-material generating module 130, the printing module 140, and the like; the RAM 1302 which stores the programs and data; the ROM 1303 which stores programs and the like for starting the computer; the HD 1304 which is an auxiliary memory (which may be a flash memory or the like); an accepting apparatus 1306 which accepts data on the basis of an operation performed by a user on a keyboard, a mouse, a touch panel, or the like; an image output device 1305, such as a cathode-ray tube (CRT) or a liquid crystal display; a communication line interface 1307 for establishing connection to a communication network, such as a network interface card; and a bus 1308 for connecting the above-described components to each other and for receiving/transmitting data. Computers having this configuration may be connected to one another via a network.

In the case where the above-described exemplary embodiment is achieved by using computer programs, the computer programs which are software are read into a system having the hardware configuration, and the software and the hardware resources cooperate with each other to achieve the above-described exemplary embodiment.

The hardware configuration in FIG. 13 is merely one exemplary configuration. The exemplary embodiment is not limited to the configuration in FIG. 13, and may have any configuration as long as the modules described in the exemplary embodiment may be executed. For example, some modules may be constituted by dedicated hardware, such as an application specific integrated circuit (ASIC), and some modules which are installed in an external system may be connected through a communication line. In addition, systems having the configuration illustrated in FIG. 13 may be connected to one another through communication lines and may cooperate with one another. In particular, the hardware configuration may be installed in home information equipment, a copier, a fax, a scanner, a printer, a multi-function device (image processing device having two or more functions of scanning, printing, copying, faxing, and the like), or the like as well as a personal computer.

The programs described above may be provided through a recording medium which stores the programs, or may be provided through a communication unit. In these cases, for example, the programs described above may be interpreted as an invention of “a computer-readable recording medium that stores a program”.

The term “a computer-readable recording medium that stores a program” refers to a computer-readable recording medium that stores programs and that is used for, for example, the installation and execution of the programs and the distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray® Disk, a magneto-optical disk (MO), a flexible disk (FD), a magnetic tape, a hard disk, a ROM, an electrically erasable programmable ROM (EEPROM®), a flash memory, a RAM, and a secure digital (SD) memory card.

The above-described programs or some of them may be stored and distributed by recording them on the recording medium. In addition, the programs may be transmitted through communication, for example, by using a transmission medium of, for example, a wired network which is used for a local area network (LAN), a metropolitan area network (MAN), a wide area network (WAN), the Internet, an intranet, an extranet, and the like, a wireless communication network, or a combination of these. Instead, the programs may be carried on carrier waves.

The above-described programs may be included in other programs, or may be recorded on a recording medium along with other programs. Instead, the programs may be recorded on multiple recording media by dividing the programs. The programs may be recorded in any format, such as compression or encryption, as long as it is possible to restore the programs.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a type generating unit that generates a type of to-be-distributed material which is to be distributed, according to a rule predetermined for each of forms of the to-be-distributed material, the type being a type in which a position at which content is described in the to-be-distributed material is determined; and
a to-be-distributed material generating unit that generates the to-be-distributed material by applying priority to the type of the to-be-distributed material and by disposing the content in the to-be-distributed material, the type being generated by the type generating unit, the priority being obtained in accordance with a distance between a first location and a second location, the first location being related to the content described in the to-be-distributed material, the second location being a distribution location for the to-be-distributed material.

2. The information processing apparatus according to claim 1,
wherein the predetermined rule is a rule that an area on a front surface of the to-be-distributed material is given a high priority in accordance with a form of the to-be-distributed material.

3. The information processing apparatus according to claim 1, further comprising:
a distance calculating unit that calculates the distance between the first location and the second location from geographic information and distribution location information, the geographic information being information representing the first location, the distribution location information being information representing the second location,
wherein the to-be-distributed material generating unit applies the priority in ascending order of the distance calculated by the distance calculating unit, and generates the to-be-distributed material.

4. The information processing apparatus according to claim 2, further comprising:
a distance calculating unit that calculates the distance between the first location and the second location from geographic information and distribution location information, the geographic information being information representing the first location, the distribution location information being information representing the second location,
wherein the to-be-distributed material generating unit applies the priority in ascending order of the distance calculated by the distance calculating unit, and generates the to-be-distributed material.

5. The information processing apparatus according to claim 3,
wherein, when the geographic information or the distribution location information is information other than coordinates information, the distance calculating unit converts the geographic information or the distribution location information into the coordinates information, and uses the coordinates information to calculate the distance between the first location and the second location.

6. The information processing apparatus according to claim 4,
wherein, when the geographic information or the distribution location information is information other than coordinates information, the distance calculating unit converts the geographic information or the distribution location information into the coordinates information, and uses the coordinates information to calculate the distance between the first location and the second location.

7. A non-transitory computer readable medium storing a program causing a computer to execute a process for information processing, the process comprising:
generating a type of to-be-distributed material which is to be distributed, according to a rule predetermined for each of forms of the to-be-distributed material, the type being a type in which a position at which content is described in the to-be-distributed material is determined; and
generating the to-be-distributed material by applying priority to the generated type of the to-be-distributed material and by disposing the content in the to-be-distributed material, the priority being obtained in accordance with a distance between a first location and a second location, the first location being related to the content described in the to-be-distributed material, the second location being a distribution location for the to-be-distributed material.

8. An information processing method comprising:
generating a type of to-be-distributed material which is to be distributed, according to a rule predetermined for each of forms of the to-be-distributed material, the type being a type in which a position at which content is described in the to-be-distributed material is determined; and
generating the to-be-distributed material by applying priority to the generated type of the to-be-distributed material and by disposing the content in the to-be-distributed material, the priority being obtained in accordance with a distance between a first location and a second location, the first location being related to the content described in the to-be-distributed material, the second location being a distribution location for the to-be-distributed material.
